(19) United States
(12) Patent Application Publication
(10) Pub. No.: US 2026/0166858 A1
(43) Pub. Date: Jun. 18, 2026

(54) METHOD FOR PRODUCING A WINDSCREEN

(71) Applicant: SAINT-GOBAIN SEKURIT FRANCE, Courbevoie (FR)

(72) Inventors: Emmanuel WALCH, HERZOGENRATH (DE); Bernard NGHIEM, HERZOGENRATH (DE); René GY, HERZOGENRATH (DE); Jeremie TEISSEIRE, HERZOGENRATH (DE)

(21) Appl. No.: 19/125,116

(22) PCT Filed: Oct. 25, 2023
(86) PCT No.: PCT/EP2023/079762

§ 371 Date: Apr. 28, 2025

(30) Foreign Application Priority Data
Oct. 28, 2022 (EP) 22204525.4

(51) Int. Cl. B32B 17/10

(52) U.S. Cl. CPC B32B 17/10146; B32B 17/10064; B32B 17/10165; B32B 17/10889; B32B 2307/412; B32B 2307/558; B32B 2307/56; B32B 2605/08

(57) ABSTRACT

A method for producing a windshield includes providing a sodium-containing outer and inner panes having, respectively, a glass transition temperature of Tg₁ and Tg₂, applying a functional agent including alkali metal ions having a larger cation radius than that of sodium ions within at least one subregion of the outer pane or over the total area of the outer pane and within at least one subregion of the inner pane or over the total area of the inner pane at a plurality of points, forming defect areas at the points of the outer pane containing the functional agent at a temperature of at least Tg₁ and at the points of the inner pane containing the functional agent at a temperature of at least Tg₂, removing the remaining functional agent, forming a layer stack from the outer pane, a thermoplastic intermediate layer and the inner pane and laminating the layer stack.

The invention relates to a method for producing a windshield, to such a windshield and to the use thereof.

Composite panes, which comprise at least two panes and at least one polymer film adhesively bonded between the panes, have been used for decades in large quantities in various technical fields, in particular in building glazing and in vehicle construction. The selection of materials used and the dimensioning of the components is made depending on the requirements of the specific intended purpose, in particular with regard to the desired mechanical load-bearing capacity of the finished glazing, taking into account the boundary conditions set by the framing and any attachments.

U.S. Pat. No. 3,437,552 A discloses composite panes comprising two glass panes and an intermediate polyvinyl butyral (PVB) layer.

U.S. Pat. No. 6,708,595 B1 discloses an armoured composite glass pane for motor vehicles, which comprises a stack sequence of a plurality of panes and a plurality of adhesive intermediate layers between them.

In the automotive industry in particular, there is a trend towards the use of thinner and therefore lighter glass in composite glass panes as part of efforts to reduce weight and thus achieve fuel and electricity savings. Nevertheless, such glazings must meet defined mechanical requirements that are fixed in relevant industrial standards. In this context, safety requirements increase not only for vehicle occupants but also for other road users, such as pedestrians. In the event of a head-on collision between a pedestrian and a car, the pedestrian is very likely to hit the hood of the car, causing their head to hit the windshield of the car. This can result in severe or even fatal injury to the pedestrian, in particular if their head smashes through the windshield and hits other objects such as the dashboard.

A particularly high level of safety is therefore required for windshields. In an accident between a car and a pedestrian, the most likely scenario is the impact of the pedestrian's head on the car's windshield. In this case, early breakage of the glass is desirable to absorb the energy of the impact and protect the head from injury. This break activates the PVB, which acts like a safety net and ensures a rather gentle impact. The severity of a head impact with the windshield is usually measured using the Head Injury Criteria (HIC). This measures the severity of an impact based on the impact-induced acceleration measured at the head. A low HIC value is equivalent to a low risk for severe head injuries. There is therefore a need for windshields that pose a low risk of collisions with pedestrians. There is also a need for cost-effective and efficient methods for producing these windshields.

WO2019245819A1 discloses a method for producing a windshield which has a lower risk of head injuries in the event of an impact of the head on the windshield. This lower risk is mainly due to mechanically generated defects in the windshield.

The intermediate layer in the windshield of JP2008133141A has a tensile stiffness of less than 3 MPa, which results in improved breaking behaviour of the window in the event of an impact.

DE1951616A1 discloses a windshield having a number of small fragments or fractions of a glass tint in order to reduce the glare effect of the windshield in road traffic.

The invention is therefore based on the object of providing an improved method for producing a windshield which has a higher impact protection, in particular in accidents involving pedestrians. The proposed method is cost-effective and efficient. The object of the present invention is also to provide a windshield with improved impact protection and the use thereof.

The object of the present invention is achieved according to the invention by a method for producing a windshield according to independent claim 1. The object is further achieved by independent claims 12 and 15. Preferred embodiments result from the dependent claims.

The invention relates to a method for producing a windshield. The method is divided into a plurality of method steps below.

In a first method step a), a sodium-containing outer pane having a glass transition temperature of Tg₁ and a sodium-containing inner pane having a glass transition temperature of Tg₂ are provided. The outer pane and the inner pane preferably have a substantially identical glass transition temperature.

By describing that the outer pane and the inner pane have a glass transition temperature Tg₁ or Tg₂, it does not mean that the inner pane and the outer pane are heated to a temperature that corresponds to the glass transition temperature Tg₁ or Tg₂. Rather, it means that the outer pane and the inner pane have just such properties that at temperatures of Tg₁ or Tg₂, respectively, they transition into a glass transition state.

For the sake of simplicity, we will refer below to a glass transition temperature Tg of the outer pane and the inner pane. The glass transition temperature Tg for the outer pane is intended to be the glass transition temperature Tg₁ and for the inner pane the glass transition temperature Tg₂. The glass transition temperature Tg defines the phase transition from a solid state to a rubbery to viscous state. The glass transition temperature Tg is also called the transformation temperature for inorganic glasses. Within the meaning of the invention, the term “glass transition temperature” refers to this transformation temperature. When the glass transition temperature Tg is exceeded, a solid glass changes into a viscous state. The term glass transition temperature is generally known to a person skilled in the art and can be measured for any glass material using standard methods known to a person skilled in the art. The glass transition temperature Tg can be measured, for example, using dynamic mechanical analysis (DMA) or dynamic differential scanning calorimetry (DSC).

In a second method step b), a functional agent is applied to a plurality of points within at least one subregion of the outer pane, preferably applied to a plurality of points within exactly one subregion of the outer pane, or the functional agent is applied to a plurality of points over the total surface of the outer pane, i.e., within the total surface area of the outer pane. In addition, a functional agent is applied to a plurality of points within at least one subregion of the inner pane, preferably applied to a plurality of points within exactly one subregion of the inner pane, or the functional agent is applied to a plurality of points over the total surface of the inner pane, i.e., within the total surface area of the inner pane. It is clear to a person skilled in the art that the functional agent is not necessarily applied only within exactly one subregion of the inner pane and within exactly one subregion of the outer pane. The functional agent may also be applied to a plurality of points within a plurality of subregions of the inner pane and within a plurality of subregions of the outer pane. In addition, the functional element may also be applied to the outer pane and the inner pane at a plurality of points over the total surface of the outer pane and/or the total surface of the inner pane. It is merely a minimum requirement that the functional agent is applied within at least one subregion of the outer pane and within at least one subregion of the inner pane. The functional agent comprises alkali metal ions having a larger cation radius than that of sodium. The functional agent can be applied to a plurality of points, for example by means of spin coating. Preferably at a rotation speed of at least 1000 rpm (revolutions per minute), particularly preferably at least 1500 rpm and in particular 2000 rpm. The spin coating method is a standard method and the procedure for coating panes with thin layers is generally known to a person skilled in the art. Alternatively, the functional agent may also be sprayed on or rolled on using a rod. Spraying or rolling it on evenly using a rod is very time-efficient and has good adaptability for possible subsequent bending of the outer and inner panes.

The functional agent is preferably applied with a substantially constant layer thickness of 100 nm to 2000 nm, particularly preferably 500 nm to 1500 nm, very particularly preferably 800 nm to 1200 nm, in particular 1000 nm to the points of the outer pane and the inner pane.

For the purposes of the invention, “a plurality of points” means at least two points. Preferably, the functional agent is applied to at least 5 points, particularly preferably at least 10 points, very particularly preferably at least 50 points and in particular at least 100 points of at least one subregion or the total area of the outer pane and at least one subregion or the total area of the inner pane (i.e., at least 5, 10, 50 or 100 points on each pane). The number of points to which the functional agent is applied can be selected depending on the subregion or the total area of the relevant pane (outer pane or inner pane), wherein the number of points preferably increases with the size of the relevant subregion.

In a third method step c), at a temperature of at least the glass transition temperature Tg₂ in the case of the inner pane and at least the glass transition temperature Tg₁ of the outer pane, defect areas are formed on the outer pane at the points of the outer pane and the inner pane that are covered with the functional agent.

In a fourth method step d), the remaining functional agent and other by-products of the defect area formation are removed from the outer pane and the inner pane. Preferably, the outer pane and the inner pane are cleaned so that optimal surfaces are available for lamination of the outer pane and the inner pane.

In a fifth method step e), a layer stack is formed from the outer pane, a thermoplastic intermediate layer and the inner pane. The thermoplastic intermediate layer is arranged for this purpose in a planar manner between the outer pane and the inner pane.

The outer pane has a surface facing the thermoplastic intermediate layer, which is referred to below as the interior-side surface of the outer pane. The outer pane further has a surface facing away from the thermoplastic intermediate layer, which surface is referred to below as the outer-side surface of the outer pane. The inner pane has a surface facing the thermoplastic intermediate layer, which is referred to below as the outer-side surface of the inner pane. The inner pane further has a surface facing away from the thermoplastic intermediate layer, which is referred to below as the interior-side surface of the inner pane.

In a sixth method step f), the layer stack is laminated to form a windshield. The windshield is therefore a composite pane having an outer pane, an inner pane and a thermoplastic intermediate layer in between.

The defect areas on the outer pane can coincide with the defect areas on the inner pane when projected onto the inner pane. The defect areas on the outer pane may also only partially, for example by chance, coincide with the defect areas on the inner pane when projected onto the inner pane. It is also possible that the defect areas on the outer pane are arranged offset from the defect areas on the inner pane when projected onto the inner pane.

The outside surface of the outer pane is simultaneously also the outer-side surface of the windshield. The interior-side surface of the inner pane is at the same time also the inner surface of the windshield. The windshield is provided for separating an external environment from a vehicle interior. The outer surface of the outer pane is provided here to face the external environment and the interior-side surface of the inner pane is provided to face the interior.

The outer pane, the inner pane and the produced windshield each have a peripheral edge, which particularly preferably comprises an upper edge and a lower edge and two side edges running between them that have a left and a right side edge. Upper edge means the edge intended to point upwards in the installed position. Lower edge means the edge intended to point downward in the installed position. The upper edge is often also referred to as the roof edge, and the lower edge is often also referred to as the engine edge. The outer pane, the inner pane and the windshield may have any suitable geometric shape and/or curvature. The indications “left” and “right” refer to the side indication or directional indication for an observer looking at the installed windshield according to the invention from a vehicle interior.

The inventors have found that a windshield produced by means of the method according to the invention has improved fracture characteristics when an object impacts the windshield in the subregion or over the total surface of the outer pane and/or the inner pane, i.e., in the region(s) provided with the defect areas. The introduced defect areas lead to a targeted weakening of the outer pane and/or inner pane, which significantly influences the fracture characteristics of the windshield in the region(s) provided with the defect areas and as a result of which an impacting body experiences a lower deceleration rate. In the method according to the invention, the defect areas are introduced by means of cation exchange. By exchanging sodium ions with alkali cations, which have a higher cation radius than sodium, in the outer pane and the inner pane, defect areas are formed in one or more subregions or over the total area of the outer pane and the inner pane. The outer pane and the inner pane have an increased thermal expansion coefficient at the defect areas. After the outer pane and the inner pane have cooled to room temperature, this increased coefficient of thermal expansion leads to an increased tensile stress, whereby the outer pane and the inner pane have improved fracture characteristics in at least one subregion.

The inventors have found that windshields having improved fracture characteristics result in less severe injuries in accidents involving pedestrians while maintaining the stone chip resistance of the windshields. In this context, improved fracture characteristics are therefore equivalent to improved impact protection of the windshield. This relationship between fracture characteristics and improved impact protection can be described by measuring the HIC value. The method therefore produces a windshield that offers improved impact protection. The inventors have also discovered that the creation of defect areas by exchanging smaller alkali cations for larger alkali cations (cation radius) in the windshield panes above the glass transition temperature Tg is a gentle method by which the fracture characteristics of the windshields can be adjusted in a targeted manner.

In the context of the invention, “at a temperature of at least the glass transition temperature Tg” may mean that the functional agent is heated to this temperature before it is applied to the outer pane or the inner pane. Alternatively, it may mean that the outer pane and the inner pane are heated to a temperature of at least the glass transition temperature Tg before the functional agent is applied to the points or after the functional agent is applied to the points of the outer pane and the inner pane. In any case, the points which are coated with the functional agent are heated to a temperature of at least the glass transition temperature Tg or the points are already heated to a temperature of at least the glass transition temperature Tg before the functional agent is applied to the points in method step c). Preferably, the outer pane and the inner pane with the functional agent are heated to a temperature of at least Tg. The formation of the defect areas at a temperature of at least Tg preferably takes place within a period of at least 10 min (minutes), particularly preferably at least 30 min, very particularly preferably at least 70 min and in particular at least 100 min. By exposing the outer pane and the inner pane to a temperature of at least Tg for a longer period, an improved exchange of the sodium ions in the glass with the potassium ions takes place. The potassium ions diffuse more deeply into the pane. “Deeper diffusion” refers to the diffusion spread of the potassium ions perpendicular to the surface of the outer pane or inner pane that is covered with the functional agent.

The formation of the defect areas in method step c) is preferably carried out at a temperature of at least Tg+10° C., particularly preferably at a temperature of at least Tg+20° C. and in particular at a temperature of at least Tg+50° C. “Tg+10° C.” means a temperature that is at least 10° C. above the temperature of Tg.

In a particularly preferred embodiment of the invention, in the third method step c), the outer pane and inner pane covered with the functional agent are arranged on supports, preferably a grid, in an oven. The furnace is heated to a temperature of at least Tg. The oven is heated, for example, by means of air circulation of heated air. This leads to an improved homogeneous formation of the defect areas.

In a preferred embodiment, the outer pane, the inner pane and the functional agent are heated to at least the glass transition temperature Tg after the second method step b). This results in fewer temperature gradients across the outer pane and the inner pane, which leads to a very homogeneous formation of defect areas.

In a preferred embodiment of the method according to the invention, the functional agent is applied to the outer pane and the inner pane at a temperature of at least the glass transition temperature Tg. The points of the outer pane and the inner pane covered with the functional agent heat up so that an efficient ion exchange can take place to form the defect areas. Alternatively, after the functional agent is applied to the points of the outer pane and the inner pane, the inner pane and the outer pane are heated to a temperature of at least the glass transition temperature Tg. The inner pane and the outer pane can be preheated in an oven, for example. The inner pane and the outer pane can be heated by an oven during the application of the functional agent, so that the application of the functional agent is carried out in an oven.

After the defect areas have formed on the outer pane and the inner pane, the outer pane and the inner pane are preferably cooled to room temperature. However, it is also possible that the outer pane and the inner pane are not cooled down initially, with the temperature instead being kept constant, cooled down to higher than room temperature or even heated to higher than at least the glass transition temperature Tg. These variants can be useful, for example, if the outer pane and the inner pane are subjected to a bending process after the defect areas have been formed.

In a preferred embodiment of the method according to the invention, the outer pane and the inner pane are bent after the fourth method step d). The inventors have found that forming defect areas on the outer pane and/or the inner pane prior to bending results in a windshield having improved fracture characteristics in accidents involving pedestrians while maintaining the stone chip resistance of the windshield. A heating of the outer pane and/or the inner pane in the bending process causes a partial healing of the created defect areas, which has a beneficial effect on the mechanical properties of the pane in question. Moreover, in practice it is much easier to manipulate a formation of defect areas of the non-curved planar panes than to machine the curved panes. However, it is also possible that in the first method step a) the outer pane and the inner pane are already bent.

The outer pane and/or the inner pane are preferably bent at a temperature of 500° C. to 700° C. The outer pane and the inner pane can be bent individually. Preferably, the outer pane and the inner pane are curved together congruently (i.e., simultaneously and by the same tool) because this optimally matches the shape of the panes to one another for the subsequent lamination.

The functional agent is preferably applied to the interior-side surface of the outer pane and to the interior-side surface of the inner pane within the relevant subregion or over the total interior surface of the outer pane and the total interior-side surface of the inner pane at a plurality of points. The defect areas which form as a result of cation exchange between the functional agent and the inner pane and the outer pane preferably have, in the top view of the surface of the inner pane and/or the outer pane provided with defect areas (i.e., two-dimensional view), a circular shape, an angular shape, for example triangular, square, rectangular, or a diffuse shape, for example semicircular, crescent-shaped. The defect areas are at least largely invisible to the naked eye; the description of the shape therefore refers to the area of the inner pane and/or the outer pane that is defined as a defect area by the cation exchange and has a higher thermal expansion coefficient than the areas of the pane without cation exchange.

In a particularly preferred embodiment, the defect areas are spherical, rectangular, rhombic, pyramidal or conical, preferably spherical. This shape is particularly advantageous in order to produce improved fracture characteristics and thus improved impact protection of the windshield.

In a particularly preferred embodiment of the method according to the invention, in the fifth method step e) during the formation of the layer stack, the inner pane and the outer pane are arranged relative to one another in such a way that the subregion of the outer pane and the subregion of the inner pane, which are provided with defect areas, are arranged substantially congruently with one another. This means that, when viewed through the windshield from the interior of a vehicle, the areas of the outer pane and the inner pane having defect areas coincide. The subregion of the inner pane covers the subregion of the outer pane when viewed from the vehicle interior. The congruent arrangement of the subregions improves the fracture characteristics of the windshield in the event of an impact. The defect areas on the outer pane and the defect areas on the inner pane can also be arranged substantially congruently with one another.

The functional agent can be formed based on a solution, a solid powder or network modifiers. Preferably, the functional agent is formed on the basis of silicate glass frits which contain network modifiers. In this case, the functional agent is preferably applied to the outer pane and the inner pane using a screen printing method. Alternatively, the functional agent is applied as a silicate-containing coating to the outer pane and the inner pane using a sol-gel process. The silicate-containing coating contains alkali metal ions, which have a larger cation radius than sodium. The alkali metal ions are preferably located in an alkaline cluster.

In a particularly preferred embodiment of the invention, the functional agent is a powder based on potassium carbonate. Potassium carbonate is particularly suitable if the outer pane and/or the inner pane is/are made of soda-lime glass.

In a particularly preferred embodiment of the invention, the functional agent is an inorganic binder containing an aqueous solution with silicate-based binder. The binder preferably has a weight proportion of the functional agent of at least 10%, particularly preferably of at least 20% and in particular of at least 25%. The ratio of potassium oxide to silicate in the binder is preferably from 0.1 to 0.4, particularly preferably from 0.2 to 0.4 (potassium oxide/silicate). Alternatively, the functional agent consists of an aqueous solution having a silicate-based binder. The binder preferably has a weight proportion of the functional agent of at least 10%, particularly preferably of at least 20% and in particular of at least 25%. The ratio of potassium oxide to silicate in the binder is preferably from 0.1 to 0.4, particularly preferably from 0.2 to 0.4 (potassium oxide/silicate). This composition was used to produce particularly uniform defect areas. The result was surprising and unexpected to the inventors.

The alkali metal ions according to the invention having a higher cation radius than sodium ions are preferably potassium ions. For the purposes of the invention, “alkali metal ions” means that the alkali metal ions can be present as free ions, for example in a solution, or as bound ions in a salt, an inorganic network or an organic network.

Network modifiers are chemicals that can be added to glass in small amounts to change the properties of the glass. These include, for example, lithium, sodium, potassium and calcium, which occur as charged individual atoms (ions) in the midst of the cross-linked network formers and reduce the relative number of strong bonds in the glass and lower the melting point and viscosity.

Particularly preferably, the functional agent is applied to the outer pane and the inner pane using the sol-gel process. Advantages of the sol-gel method as a wet-chemical method is a high flexibility which, for example, allows only parts of the pane surface to be provided with the coating in an easy manner. The sol-gel coating functional agent preferably contains potassium ions. The chemical conversion of the sol-gel is helpful in avoiding problems during temperature treatments.

In the sol-gel method, a sol which contains the precursors of the coating is first provided and matured. Maturing may include hydrolysis of the precursors and/or a (partial) reaction between the precursors. The precursors are usually present in a solvent-preferably water, alcohol (in particular, ethanol), or a water-alcohol mixture.

In one embodiment, the sol-gel coating is formed on the basis of potassium oxide and/or potassium carbonate. The sol contains potassium oxide precursors and/or potassium carbonate.

The sol is applied indirectly or directly to the inner pane and the outer pane, in particular by wet chemical methods, for example by flow coating, by application using brushes, or by spray coating, or by printing methods, for example by pad printing or screen printing. The inner pane and/or outer pane can be masked in areas beforehand so that only those points of the inner pane and/or outer pane at which the defect areas are to be formed according to the invention are coated with the sol. Drying can then take place, whereby solvent is evaporated. This drying can be done at ambient temperature or by separate heating. Before the functional agent is applied to the outer pane and the inner pane, the surface is typically cleaned by known methods.

The sol is then condensed. Condensation can comprise a heat treatment which can be carried out as a separate heat treatment at, for example, a temperature higher than Tg₁ and/or higher than Tg₂, alternatively at up to 500° C. or in the context of a glass bending process, typically at temperatures of 600° C. to 700° C. If the precursors have UV-crosslinkable functional groups (for example a methacrylate, vinyl, or acrylate group), condensation can comprise a UV treatment. Alternatively, with suitable precursors (for example, silicates), the condensation can comprise an IR treatment. Optionally, solvent can be evaporated, for example at a temperature of up to 120° C.

If something is formed “on the basis” of a material, it consists predominantly, that is to say at least 50%, preferably at least 70%, very particularly preferably at least 90% and in particular at least 99%, of this material.

The functional agent is particularly preferably printed onto the outer pane and the inner pane, in particular using the screen printing method. The functional agent is printed through a fine-meshed fabric onto the outer pane and the inner pane. The functional agent is pressed through the fabric with a rubber squeegee, for example. The fabric has areas that are permeable to the functional agent, as well as areas that are impermeable to the functional agent, thereby determining the geometric shape of the print (shapes of the points of the outer pane and the inner pane that are affected by the functional agent and are converted into defect areas). The fabric thus acts as a template for the print. The functional agent contains at least alkali metal ions having a higher cation radius than sodium ions and the glass frits, suspended and/or dissolved in a liquid phase (solvent), for example water or organic solvents, such as alcohols. The alkali metal ions are preferably potassium ions.

If coatings, such as sun protection coatings or heatable coatings, are to be applied to the surfaces of the outer pane and the inner pane facing the thermoplastic intermediate layer (interior-side surface of the outer pane and outer-side surface of the inner pane), the arrangement of the inner pane and the outer pane together with the thermoplastic intermediate layer to form the layer stack is provided preferably after the coating has been applied and the defect areas have been introduced into the outer pane and the inner pane. If the windshield comprises coatings that are to be electrically contacted, the electrically conductive layers are electrically contacted via busbars or other suitable electrical conductors before the windshield is laminated.

Any opaque cover prints applied to the edge of the windshield are preferably applied using the screen printing method. If an opaque cover print and the functional agent are to be applied to the same pane surface, they are preferably applied one after the other. The outer pane and inner pane are connected via the thermoplastic intermediate layer to form the windshield, preferably by lamination under the effect of heat, vacuum and/or pressure. Methods known per se for producing a windshield can be used.

During lamination, the heated, flowable thermoplastic material flows, so that a stable bond is produced. For example, so-called autoclave methods can be carried out at an elevated pressure of approximately 10 bar to 15 bar and at temperatures of 130° C. to 145° C. for approximately 2 hours. Vacuum bag or vacuum ring methods known per se operate, for example, at approximately 200 mbar and 80° C. to 110° C. The outer pane, the thermoplastic intermediate layer, and the inner pane can also be pressed in a calender between at least one pair of rollers to form a pane. Systems of this type are known for producing panes and normally have at least one heating tunnel upstream of a pressing unit. The temperature during pressing is, for example, from 40° C. to 150° C. Combinations of calender and autoclave methods have proven particularly successful in practice. Vacuum laminators can be used as an alternative. These consist of one or more heatable and evacuable chambers, in which the panes are laminated within, for example, approximately 60 minutes at reduced pressures of 0.01 mbar to 800 mbar and temperatures from 80° C. to 170° C.

The invention further relates to a windshield comprising at least an outer pane made of soda-lime glass having an outer-side surface and an interior-side surface and an inner pane made of soda-lime glass having an outer-side surface and an interior-side surface, wherein the interior-side surface of the outer pane and the outer-side surface of the inner pane are connected to one another via a thermoplastic intermediate layer. The windshield comprises, at least in a subregion of the outer pane and at least in a subregion of the inner pane, defect areas which are introduced into the outer pane and the inner pane. The defect areas were created at a temperature of at least the glass transition temperature Tg by introducing alkali metal ions, which have a higher cation radius than sodium ions. To the same extent that alkali metal ions, which have a higher cation radius than sodium ions, were introduced into the outer pane and the inner pane, sodium ions were removed from the inner pane and the outer pane. For the purposes of the invention, the “glass transition temperature Tg” means the glass transition temperature Tg₂ of the inner pane and the glass transition temperature Tg₁ of the outer pane. The glass transition temperature Tg₁ and the glass transition temperature Tg₂ are preferably substantially identical but may also be different.

The invention also extends to a windshield produced according to the method according to the invention.

In a preferred embodiment of the windshield produced according to the invention, the defect areas form a regular or irregular pattern and adjacent defect areas have an average distance of 5 cm to 50 cm, preferably 10 cm to 30 cm, from one another.

In a further preferred embodiment of the windshield produced according to the invention, the defect areas are formed within exactly one subregion of the outer pane and within exactly one subregion of the inner pane.

The introduced defect areas reduce the strength of the glass. The inventors have made use of this generally undesirable effect to influence the fracture characteristics of the windshield. The targeted weakening of the outer pane and inner pane of the windshield leads to early breakage in the event of a body impact. After one or both of the glass panes break, a considerable amount of energy is absorbed due to the expansion of the thermoplastic intermediate layer and the at least partial delamination in the region of the broken glass panes. The thermoplastic intermediate layer is expandable and therefore yields, so that an impinging human head slows down less abruptly and experiences a lower deceleration rate. An abrupt deceleration of the head, as occurs in the case of a late glass breakage, should be avoided. A windshield not according to the invention without defect areas shows a late glass fracture in the event of a head impact, wherein a large part of the kinetic energy of the impact is dissipated by the bending of the glass, which leads to a high deceleration rate of the head. To quantify this head impact, the Head Injury Criterion (HIC) is used, for example, which assesses the severity of an impact based on the deceleration rate of the head. Methods for determining HIC values are generally known to a person skilled in the art. HIC values can be determined, for example, using ISO/TR 12351:1999.

High deceleration rates are usually associated with high HIC values, which are associated with severe injuries to the head of the pedestrian. A low HIC value is equivalent to a low risk for severe head injuries. The strength is lower in regions where the defect areas have been deliberately introduced. As a rule, a glass breakage always begins at a defect in the glass if tensile stress is exerted in this region. Minor statistically distributed defects can be detected in glass panes due to the production process. However, their influence on the breaking behaviour is not predictable, due to the statistical distribution of such natural defects. The defect areas introduced according to the invention in at least one subregion of the outer pane and at least one subregion of the inner pane may, in contrast to the random defects in the glass, be specifically placed in a region of the windshield in which an early breakage is to occur. As a result, the windshield according to the invention also offers greater safety for a passer-by in the event of a traffic accident involving the passer-by, since the severity of the impact of the human head in the event of a head-on collision is mitigated by early breakage of the windshield.

The windshield is provided for separating a vehicle interior from an external environment. The windshield is therefore a window pane that is inserted into a window opening in the vehicle body or is provided for this purpose. The outer pane of the windshield faces the outside of the vehicle, while the inner pane is oriented toward the interior of the vehicle. It is understood that the inner pane, the outer pane and the thermoplastic intermediate layer have substantially the same outer dimensions.

The windshield according to the invention preferably has a first surface area which coincides with the region(s) of the inner pane provided with the defect areas and the region(s) of the outer pane provided with the defect areas when viewed through the windshield. This first surface area comprises at least a portion of the surface area of the windshield, but may also comprise the total pane surface of the windshield. If the first surface area covers less than the total pane surface of the windshield, the region not covered by the first surface area is referred to as the second surface area of the windshield. The second surface area therefore does not overlap with the at least one subregion of the inner pane and the at least one subregion of the outer pane. The second surface area thus comprises regions in which no defect areas produced according to the invention are present. A plurality of first surface areas and/or second surface areas may also be present, wherein the first surface areas comprise defect areas, while the second surface areas are free of defect areas. In a preferred embodiment, the windshield has only a first surface area and a second surface area, which together cover the total area of the windshield.

The thermoplastic intermediate layer may comprise one or more films. The at least one film can have electrically switchable functions or tinted regions. The thermoplastic intermediate layer thus can have a single-layer or multi-layer structure. In one possible embodiment, the thermoplastic intermediate layer is designed as a film laminate, for example as a film laminate having three layers.

The defect areas are preferably introduced in the interior-side surface of the outer pane and the interior-side surface of the inner pane. It has been shown that very good fracture characteristics can be achieved while having a simultaneously low number of defect areas. In this way, resources and process times can be saved.

The diameter of the defect areas is preferably 10 μm to 500 μm, particularly preferably 15 μm to 250 μm. The diameter of a defect area is determined as the maximum diameter of the defect area, i.e. the maximum measurable extent of the defect area. This made it possible to achieve reliable fracture of the pane, while at the same time keeping the surface with a defect small in order to save costs and avoid visual impairments. The diameter of the defect areas is measured as the total diameter of the measurable defect caused by cation exchange.

Preferably, the defect areas form a regular or irregular pattern within the at least one subregion of the outer pane and the at least one subregion of the inner pane. Alternatively, the defect areas form a regular or irregular pattern over the total surface of the outer pane and the total surface of the inner pane. Preferably, the defect areas form a regular or irregular pattern within the first surface area of the windshield. Defect areas adjacent to one another within a plane are preferably arranged at an average distance of 1 cm to 50 cm, preferably 2 cm to 30 cm, particularly preferably 3 cm to 15 cm, for example 5 cm to 10 cm, from one another. This has proven to be advantageous, so that a head hitting the windshield always strikes near a defect area in the outer pane. For the purposes of the invention, “adjacent defect areas” are defect areas that are arranged closest to one another. Explained by an example, this means: the defect area b is the adjacent defect area to defect area a if it is the defect area that has the smallest distance to defect area a. At the same time, defect area c can be the defect area adjacent to defect area b if it is the defect area that has the smallest distance to defect area b. The mean distance is the arithmetically averaged distance over all distances of the adjacent defect areas.

In a particularly preferred embodiment of the invention, the defect areas are only introduced within exactly one subregion of the outer pane and exactly one subregion of the inner pane. Preferably, the subregion of the outer pane in which defect areas are introduced takes up between 10% and 90%, preferably 20% to 90%, particularly preferably 30% to 70%, of the total area of the outer pane. Preferably, the subregion of the inner pane in which defect areas are introduced takes up between 10% and 90%, preferably 20% to 90%, particularly preferably 30% to 70%, of the total area of the outer pane. Preferably, the first surface area of the windshield in which defect areas are introduced takes up between 10% and 90%, preferably 20% to 90%, particularly preferably 30% to 70% of the total area of the outer pane. Tests have shown that the aforementioned preferred surface portions of the subregion or surface area are sufficient to achieve a good level of safety. Alternatively, the defect areas are not only introduced in the subregion of the outer pane and in the subregion of the inner pane, but are distributed over the total surface of the outer pane and the total surface of the inner pane.

The characterization of the windshields and individual glass panes (inner pane and/or outer pane) can be carried out, for example, using SIMS (secondary ion mass spectrometry). The implementation of SIMS methods for the characterization of panes is generally known to a person skilled in the art. By means of SIMS, a measurement can be made of the extent of ion exchange in a pane before the method according to the invention compared to after the method according to the invention.

The peripheral edge of the windshield has four portions that, in relation to the installation location of the windshield in a motor vehicle, are referred to as the engine edge, roof edge and side edges, wherein two opposing side edges connect the engine edge and the roof edge. The engine edge (lower edge) is designed to face the ground in the installation position, whereas the roof edge (upper edge) is designed to face the sky. The windshield has a transmission of at least 70% in the visible range of the light spectrum (this means the light transmission in accordance with ISO 9050:2003). In particular, in the main field of vision of the windshield, also known as the A-field, a transmission of at least 70% in the visible range is required in order to meet the legal regulations for windshields (ECE-R 43, Annex 3, Sec. 9.1 Method for testing the light transmittance of motor vehicle panes). If a region with defect areas extends into the main field of vision of the windshield, the transmission should be 70%; in other regions, a lower transmission is sufficient. Preferably, the regions of the outer pane and/or the inner pane in which the defect areas are located is a region adjacent to the edge of the engine in which the head of a pedestrian is more likely to hit in the event of an accident.

In one possible embodiment, the defect areas produced according to the invention are applied only in exactly one subregion of the inner pane and in exactly one subregion of the outer pane. The density of the defect areas, i.e., the number of defect areas per surface unit, decreases within this one subregion of the outer pane and/or this one subregion of the inner pane from the edge of the engine toward the edge of the roof. Adjacent to the upper edge of the subregion of the outer pane and/or of the subregion of the inner pane, the density of defect areas is therefore lower than the density of defect areas adjacent to the motor edge. In this way, a gradual transition can be created between the subregion of the outer pane and/or the inner pane and a further subregion without defect areas that is adjacent to this subregion.

The at least one subregion of the outer pane and the at least one subregion of the inner pane can in principle have any shape and preferably have the shape of a rectangle or a rounded rectangle or a semicircle or a semi-ellipse or a trapezoid, each adjacent to the motor edge of the windshield. Depending on the geometry of the windshield, other forms are also expedient.

In a preferred embodiment, the upper edge of the at least one subregion of the outer pane and/or the upper edge of the at least one subregion of the inner pane runs in a straight line between the side edges and terminates at the side edges of the windshield. For a straight-line upper edge, a course horizontal in the installed state of the windshield in the vehicle has proven to be advantageous in order to achieve the desired reduction in strength in the subregion uniformly in all regions along the engine edge. In a further preferred embodiment, the upper edge has a curved profile. The upper edge can end in the region of the side edges or can also run towards the corner regions and end directly in the corner region or at the portions of the engine edge adjacent to the corner region. This results in a semicircular or semi-elliptical geometry of the subregion of the outer pane and/or the subregion of the inner pane.

The thermoplastic intermediate layer preferably comprises polyvinyl butyral (PVB), polyurethane (PU), ionomers and/or ethylene vinyl acetate (EVA), particularly preferably PVB. These materials have proven to be particularly suitable with regard to a secure connection of the inner pane and the outer pane to one another. The thickness of the thermoplastic intermediate layer is preferably between 300 μm and 1000 μm, particularly preferably between 500 μm and 900 μm, in particular between 650 μm and 850 μm.

Independently of one another, the outer pane and the inner pane can be made of non-prestressed, partially prestressed or prestressed glass. If the outer pane and/or the inner pane are to be prestressed, this can be a thermal or chemical prestressing. The outer pane and the inner pane in each case preferably have a thickness of 0.8 mm to 2.5 mm, particularly preferably from 1.2 mm to 2.2 mm. The thickness of the outer pane is typically between 1.0 mm and 2.5 mm. The thickness of the inner pane is preferably between 0.8 mm and 2.1 mm. The thickness of the outer pane is preferably greater than the thickness of the inner pane. For example, the outer pane can be 2.1 mm thick and the inner pane 1.1 mm thick, or the outer pane 1.8 mm thick and the inner pane 1.4 mm thick, or the outer pane 1.6 mm thick and the inner pane 1.1 mm thick, or the outer pane 1.6 mm thick and the inner pane 0.7 mm thick, or the outer pane 1.4 mm thick and the inner pane 1.1 mm thick.

The inner pane, the outer pane and the thermoplastic intermediate layer can be clear and colourless, but can also be tinted or coloured. The tinting of the outer pane, inner pane and the thermoplastic intermediate layer is selected depending on the desired application of the windshield. For windshields, high transmission in the visible range of the light spectrum is desired and dark tinting of the components is omitted.

The windshield according to the invention is curved in one or preferably in a plurality of directions of space, as is usual for windshields of motor vehicles, wherein typical radii of curvature are in the range from about 10 cm to about 40 m. The inner pane, the outer pane, and/or the thermoplastic intermediate layer can have further, suitable coatings known per se, e.g., anti-reflective coatings, non-stick coatings, anti-scratch coatings, photocatalytic coatings or sun protection coatings or low-e coatings.

Windshields usually have a peripheral cover print made of an opaque enamel, which cover print serves in particular to protect the adhesive used for installing the windshield from UV radiation and to visually conceal said adhesive. Preferably, at least the outer pane has such an opaque peripheral cover print, particularly preferably both the outer pane and the inner pane are printed, so that the through-view from either side is prevented. The opaque cover print is applied in the form of a screen print, for example, so that this screen print circumscribes the field of view of the pane or forms its outer edge. Any electrical conductors located in the edge area of the pane and, in the case of coated panes, an optionally provided coating-free edge region are preferably covered by this cover print and are therefore optically concealed. The opaque screen print can be applied in any plane of the windshield.

All the standards mentioned relate to their version valid as on the filing date of the invention.

The invention further extends to the use of a windshield produced according to the method according to the invention in means of transport for traffic on land, in the air or on water, in particular in motor vehicles.

The various embodiments of the invention can be implemented individually or in any combinations. In particular, the features mentioned above and yet to be explained below can be used, not only in the specified combinations, but also in other combinations or alone without departing from the scope of the invention. That is the case unless exemplary embodiments and/or their features are explicitly mentioned only as alternatives or are mutually exclusive. In particular, the features described in the context of the method according to the invention also apply to the windshield, and vice versa.

The invention is explained in more detail below with reference to exemplary embodiments, wherein reference is made to the accompanying figures. The figures (Fig.) are schematic representations and are not true to scale. The figures do not limit the invention in any way. In the drawings:

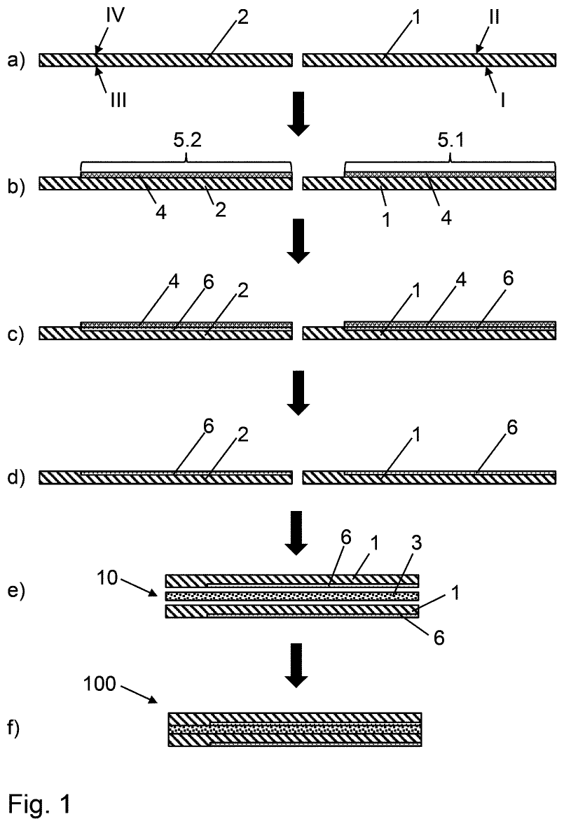

FIG. 1 shows an embodiment of the method according to the invention in a cross-sectional view,

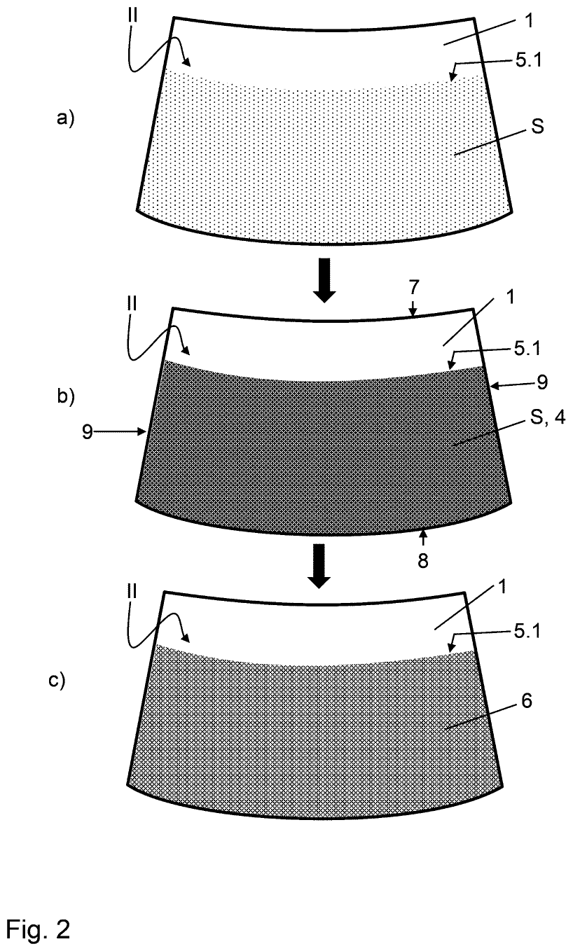

FIG. 2 shows the first three steps a) to c) of the method according to the invention in a plan view of the outer pane of the windshield,

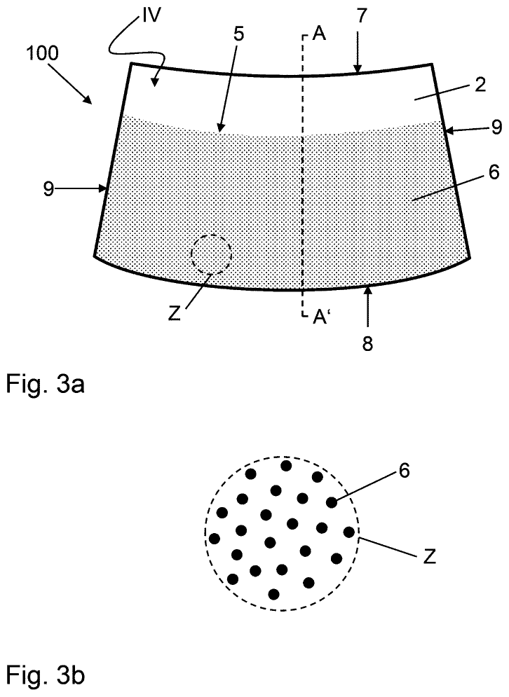

FIG. 3a shows a windshield produced according to the method according to the invention in FIG. 1 in a plan view,

FIG. 3b shows an enlarged portion of the windshield from FIG. 3a,

FIG. 3c shows the windshield from FIG. 3a in a cross-sectional view,

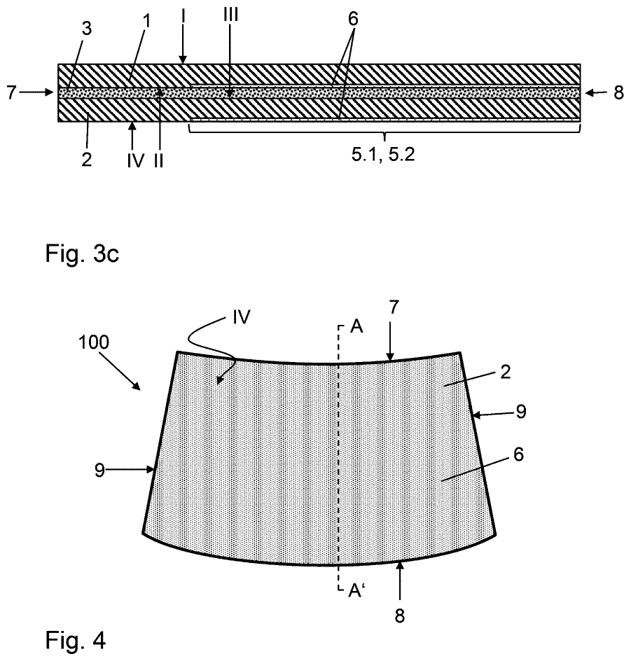

FIG. 4 shows a further embodiment of the windshield according to the invention produced by the method according to the invention and

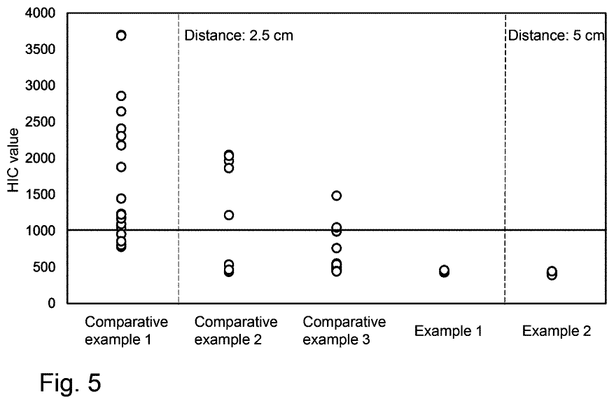

FIG. 5 shows a diagram with HIC values of generic windshields and of windshields produced by the method according to the invention.

FIG. 1 shows an embodiment of the method according to the invention with the individual method steps a) to f). In FIG. 1 the intermediate products and the product after each method step are shown. The intermediate products and the product, i.e., the windshield 100, are shown in a cross-sectional view, which means that no top view of one of the main surfaces of the windshield 100 or the intermediate products is shown, but rather a view of a cross section. The cross-sectional line AA′ along which the intermediate products and windshield 100 are cut is indicated, for example, in FIG. 3a. FIG. 2 shows a further aspect of the embodiment of the method according to the invention; the method steps a) to c) are shown in a plan view using the outer pane 1.

In a first method step a) an outer pane 1 and an inner pane 2 are provided. The outer pane 1 and the inner pane 2 are, for example, transparent soda-lime glass panes. The outer pane 1 has, for example, a thickness of 2.1 mm and the inner pane 2 has, for example, a thickness of 1.6 mm. The outer pane 1 and the inner pane 2 are, for example, curved according to the requirements of a windshield for a passenger car (curvature not shown) and have the required dimensions. Alternatively, the outer pane 1 and the inner pane 2 may also be uncurved, i.e., flat, such as flat glass that has already been cut to the desired dimensions.

Moreover, the outer pane 1 has an outer-side surface I and an interior-side surface II. The inner pane 2 likewise has an outer-side surface III and an interior-side surface IV. The interior-side surfaces II, IV of the outer pane 1 and the inner pane 2 are intended to face the vehicle interior in the finished windshield 100 in the installed position in a vehicle. The outer-side surface I, III of the outer pane 1 and the inner pane 2 are intended to face the external environment in the finished windshield 100 in the installed position in a vehicle.

In a second method step, a functional agent 4 is applied in a subregion 5.1 of the outer pane 1 and in a subregion 5.2 of the inner pane 2. The subregion 5.1 of the outer pane 1 and the subregion 5.2 of the inner pane 2 do not extend over the total outer pane 1 and inner pane 2, but only over approximately 80% of the surface of the inner pane 2 and the outer pane 2. The subregion 5.1, 5.2 of the outer pane 1 or the inner pane 2 extends from the lower edge 8 to an upper edge line which is offset from the upper edge 7 but substantially parallel to the upper edge 7. The subregion 5.1, 5.2 of the outer pane 1 or the inner pane 2 therefore does not extend completely from the lower edge 8 to the upper edge 7 of the outer pane 1 or the inner pane 2. The remaining region between the upper edge 7 and the upper edge line of the subregion 5.1, 5.2 makes up approximately 20% of the surface of the outer pane 1 or the inner pane 2. The subregion 5.1, 5.2 of the outer pane 1 or the inner pane 2, however, extends between the upper edge line and the lower edge 8 completely from one (left) side edge 9 to the other (right) side edge 9.

The functional agent 4 is applied to different points S of the interior-side surface II of the outer pane 1 and the interior-side surface IV of the inner pane 2. Points S refer to small, separate regions on the interior-side surface II, IV of the inner pane 2 and the outer pane 1. The functional agent 4 is applied, for example, as an irregular pattern in dot form to the points S of the interior-side surface II, IV of the inner pane 2 and the outer pane 1 within the subregion 5.1, 5.2. For example, the arithmetic mean diameter of the points S provided with the functional agent 4 is 50 μm. The points S provided with the functional agent 4 are, for example, 5 cm apart on average and extend as an irregular pattern over the total subregion 5.1, 5.2 of the outer pane 1 and the inner pane 2 (in plan view, for example, a pattern as shown in FIG. 3b results). The functional agent contains, for example, potassium carbonate (K₂CO₃). It is applied, for example, using the sol-gel method.

In a third method step c), the outer pane 1 and the inner pane 2 are heated, for example in an oven, to a temperature of 600° C. The temperature 600° C. is above the glass transition temperature Tg₂ of the inner pane 2 and the glass transition temperature Tg₁ of the outer pane 1 (Tg₁ and Tg₂ for example approx. 550° C. for outer pane 1 and inner pane 2). By heating the outer pane 1 and the inner pane 2, the functional agent is melted, creating a molten potassium salt. The potassium ions diffuse into the outer pane 1 and the inner pane 2 at the points S provided with the functional agent. In contrast, sodium ions diffuse out of the panes to the same extent, so that potassium accumulates in the outer pane 1 and the inner pane 2, whereas at the same time the amount of sodium in the panes is reduced. In this way, defect areas 6 are formed in the outer pane 1 and the inner pane 2, which form at the points S. At the defect areas, the coefficient of thermal expansion (CTE) of the glass is increased, which is due to the higher ionic radii of the potassium cations compared to the sodium ions.

If the inner pane 2 and the outer pane 1 are not curved, the inner pane 2 and the outer pane 1 can be curved according to method step c) in accordance with the specifications for the windshield 100 to be produced (not shown here).

In a fourth method step d), the outer pane 1 and the inner pane 2 are cooled down to room temperature. After the inner pane 2 and the outer pane 1 have cooled to room temperature, the formed defect areas 6 have an increased tensile stress compared to the other areas of the panes. The functional agent 4 and preferably also other contaminants are removed from the surfaces I, II, III, IV of the outer pane 1 and the inner pane 2.

In a fifth method step e), the outer pane 1 and the inner pane 2 are arranged together with a thermoplastic intermediate layer 3 to form a layer stack 10. The thermoplastic intermediate layer is arranged flat between the outer pane 1 and the inner pane 2, wherein the interior-side surface II of the outer pane 1 and the outer-side surface III of the inner pane 2 face one another. The thermoplastic intermediate layer 3 is formed, for example, on a basis of polyvinyl butyral and has a thickness of 0.5 mm.

In a last and sixth method step f), the layer stack 10 is laminated to form the windshield 100 according to the invention, for example by means of the autoclave method.

FIG. 3a shows a plan view of the windshield 100 produced by the method according to the invention described in FIG. 1 and FIG. 2. A dashed circle indicates an enlarged section Z of the windshield 100, which is shown in FIG. 3b. Due to the defect areas 6 on the interior-side surface II of the outer pane 1 in the subregion 5.1 and the defect areas 6 on the interior-side surface IV of the inner pane 2 in the subregion 5.2, the windshield 100 has a lower Head Injury Criterion (HIC) in the subregion 5 compared to windshields of the same type. The subregion 5.1 of the outer pane 1 and the subregion 5.2 of the inner pane 2 are arranged substantially congruently to one another (when viewed through the windshield 100). Subregion 5 of the windshield 100 refers to that subregion of the windshield 100 which, when viewed through the windshield 100, coincides with subregion 5.1 of the outer pane 1 and subregion 5.2 of the inner pane 2.

FIG. 3c shows a cross section of the embodiment of the windshield 100 from FIG. 3a. The cross-section line A-A′ is indicated by a dashed line in FIG. 3a.

FIG. 3b shows an enlarged section Z of the windshield 100 in the subregion 5 with a view of the interior-side surface IV of the inner pane 2. In the enlarged section Z, defect areas 6 are shown in an irregular pattern on the interior-side surface IV. The defect areas 6 are formed in the form of filled circles in plan view and have a diameter of, for example, 50 μm on average. The defect areas 6 are offset from one another and therefore do not touch one another. The arithmetic mean distance of one defect area 6 to the next defect area 6 is, for example, 5 cm. The defect areas 6 can also have shapes other than filled circles in plan view; for example, they can be rectangular, rhombic, pyramidal or conical. The defect areas 6 can also form a regular pattern (not shown here).

FIG. 4 shows a further embodiment of the windshield 100 produced by the method according to the invention in plan view of the interior-side surface IV of the inner pane 2. The variants shown in FIG. 4 corresponds substantially to the variant from FIG. 3a to 3c, so that only the differences will be discussed here, and reference is otherwise made to the description relating to FIG. 3a to 3c. In contrast to the variant shown in FIG. 3a to 3c, the defect areas 6 in FIG. 4 extend not only over a subregion 5.1 of the interior-side surface II of the outer pane 1 and over a subregion 5.2 of the interior-side surface IV of the inner pane 2, but over the total interior-side surface II of the outer pane 1 and the total interior-side surface IV of the inner pane 2.

FIG. 5 shows a diagram with three generic windshields and two windshields 100 according to the invention. The windshields 100 according to the invention are illustrated by Example 1 and Example 2 in the diagram. The generic windshields are shown in the diagram by Comparative Examples 1 to 3. The structure of the windshields is substantially the same for all examples and comparative examples and is as described for FIG. 3a to FIG. 3c. The windshields differ from the windshield 100 described for FIG. 3a to 3c as follows:

Comparative example 1: the windshield has no defect areas 6.

Comparative example 2: The windshield only has defect areas 6 in a subregion 5.1 on the interior-side surface II of the outer pane 1. The arithmetic mean distance between one defect area 6 and the next defect area 6 is 2.5 cm.

Comparative example 3: The windshield only has defect areas 6 in a subregion 5.2 on the interior-side surface IV of the inner pane 2. The arithmetic mean distance between one defect area 6 and the next defect area 6 is 2.5 cm.

Example 1: The windshield 100 has defect areas 6 in a subregion 5.1 on the interior-side surface II of the outer pane 1 and in a subregion 5.2 on the interior-side surface IV of the inner pane 2. The arithmetic mean distance between one defect area 6 and the next defect area 6 is 2.5 cm.

Example 2: The windshield 100 has defect areas 6 in a subregion 5.1 on the interior-side surface II of the outer pane 1 and in a subregion 5.2 on the interior-side surface IV of the inner pane 2. The arithmetic mean distance between one defect area 6 and the next defect area 6 is 5 cm.

The comparative examples and the examples according to the invention are plotted against experimentally determined Head Injury Criteria values (HIC value) in the diagram in FIG. 5. Each entry in the diagram shows a simulated accident and the resulting HIC value. If all or almost all entries have a HIC value of less than 1000, this means good protection against head injuries in the event of a collision between the head and the windshield (installed in a moving car). If a significant number of entries have a HIC value of over 1000, this means poorer protection against head injuries. In FIG. 5 it can be seen that the windshields 100 according to the invention in Examples 1 and 2 reduce the risk of injury to the head due to an impact with the windshield 100 compared to the windshields of comparative examples 1 to 3. All entries in examples 1 and 2 are below a HIC value of 1000. For comparative examples 1 to 3, however, the risk of head injuries is significantly higher, as some entries are above a HIC value of 1000.

### LIST OF REFERENCE SIGNS

1 Outer pane
2 Inner pane
3 Thermoplastic intermediate layer
4 Functional agents
5 Subregion of the windshield 100
5.1 Subregion of the outer pane 1
5.2 Subregion of the outer pane 2
6 Defect areas
7 Upper edge
8 Lower edge
9 Side edge
10 Layer stack
100 Windshield
I Outer-side surface of the outer pane 1
II Interior-side surface of the outer pane 1
III Outer-side surface of the inner pane 2
IV Interior-side surface of the inner pane 2
S Designated points for coating with the functional agent 4
Z Enlarged section of the windshield 100 in plan view
A-A′ Section line

1. A method for producing a windshield, the method comprising:
a) providing a sodium-containing outer pane having a glass transition temperature of Tg₁ and a sodium-containing inner pane having a glass transition temperature of Tg₂,
b) applying a functional agent comprising alkali metal ions having a larger cation radius than that of sodium ions within at least one subregion of the outer pane or over a total area of the outer pane and within at least one subregion of the inner pane or over a total area of the inner pane at a plurality of points,
c) forming defect areas at the points of the outer pane containing the functional agent at a temperature of at least Tg₁ and at the points of the inner pane containing the functional agent at a temperature of at least Tg₂,
d) removing the remaining functional agent from the outer pane and the inner pane,
e) forming a layer stack from the outer pane, a thermoplastic intermediate layer and the inner pane and
f) laminating the layer stack to form a windshield.

2. The method according to claim 1, wherein the functional agent at a temperature of at least the glass transition temperature Tg₁ is applied to the outer pane and at a temperature of at least the glass transition temperature Tg₂ is applied to the inner pane.

3. The method according to claim 1, wherein after the application of the functional agent the outer pane is heated to a temperature of at least Tg₁ and the inner pane to a temperature of at least Tg₂.

4. The method according to claim 1, wherein the outer pane and the inner pane are bent following method step d).

5. The method according to claim 4, wherein the outer pane and the inner pane are bent at a temperature of 500° C. to 700° C.

6. The method according to claim 1, wherein the defect areas are spherical, rectangular, rhombic, pyramidal or conical.

7. The method according to claim 1, wherein in step e) the outer pane is arranged relative to the inner pane such that the subregion of the outer pane is substantially congruent with the subregion of the inner pane.

8. The method according to claim 1, wherein the functional agent is a powder on a potassium carbonate basis.

9. The method according to claim 1, wherein the functional agent contains glass frit particles which are based on silicate with alkali metal ions.

10. The method according to claim 9, wherein in step b) the functional agent is printed onto the outer pane and the inner pane by screen printing.

11. The method according to claim 1, wherein the functional agent is applied to an interior-side surface of the outer pane and the inner pane.

12. A windshield manufactured according to claim 1.

13. The windshield according to claim 12, wherein the defect areas form a regular or irregular pattern and mutually adjacent defect areas have an average distance of 5 cm to 50 cm from one another.

14. The windshield according to claim 12, wherein the defect areas are formed within exactly one subregion of the outer pane and within exactly one subregion of the inner pane.

15. A method comprising providing a windshield according to claim 12 in a transportation vehicle for traffic on land, in the air, or on water.

16. The method according to claim 6, wherein the defect areas are spherical.

17. The windshield according to claim 13, wherein the average distance is from 10 cm to 30 cm.

18. The method according to claim 15, wherein the transportation vehicle is a motor vehicle.
